(19) United States
(12) Patent Application Publication
(10) Pub. No.: US 2024/0427312 A1
(43) Pub. Date: Dec. 26, 2024

(54) SYSTEM AND METHOD FOR AN AUTOMATED MASS BALANCE FEEDSTOCK DEMAND

(71) Applicant: BASF SE, Ludwigshafen (DE)

(72) Inventors: Juergen DECKER, Ludwigshafen (DE); Ana ALBA PEREZ, Ludwigshafen (DE); Claus TEUBER, Ludwigshafen (DE); Olaf HUBER, Ludwigshafen (DE); Heiko STREICHERT, Ludwigshafen (DE); James H. Ehlers, Florham Park, NJ (US)

(21) Appl. No.: 18/337,728

(22) Filed: Jun. 20, 2023

(51) Int. Cl. G05B 19/4155

(52) U.S. Cl. CPC G05B 19/4155; G05B 2219/32287

(57) ABSTRACT

Disclosed are computer-implemented systems and methods for an automated determination of a mass balance feedstock demand for chemical products produced in a chemical production process of a production plant.

### TECHNICAL FIELD

The present disclosure relates to methods, apparatuses and systems for producing at least two chemical products from one or more input materials(s) and for determining the feedstock demand associated with producing the at least two chemical products based, at least in part, on feedstock demand calculation logic.

### TECHNICAL BACKGROUND

In production processes, the allocation of feedstock demand to co-products is of great interest. The allocation of sustainable feedstock demand can aid the collective reduction of environmental impacts to combat climate change. The accuracy of the allocations, however, is hindered by systems that do not account for the differing characteristics that co-products may have when they are different materials. Thus, there is a need to develop systems and methods that more accurately determine and allocate the sustainable feedstock demand of co-products.

### SUMMARY OF THE INVENTION

In an aspect, the disclosure relates to a computer-implemented method for determining a feedstock demand for two or more chemical products produced in a chemical production process of a production plant comprising:
receiving input material data associated with one or more input materials to the chemical production process;
receiving process data for one or more process steps in the chemical production process;
receiving consumption data indicating an amount of feedstock associated with producing two or more chemical products;
identifying based on the process data at least one process step producing from the one or more input materials two or more chemical products, wherein the two or more chemical products includes a first chemical product and a second chemical product;
determining based, at least in part, on steering logic a substituted feedstock demand for the first chemical product, if the deviation value for the first chemical product exceeds the target value;
calculating a feedstock demand for the second chemical product based, at least in part, on the substituted feedstock demand for the first chemical product and the consumption data; and
outputting the substituted feedstock demand for the first chemical product and the feedstock demand for the second chemical product.

In another aspect, the disclosure relates to a computer-implemented method for determining a feedstock demand for two or more chemical products produced in a chemical production process of a production plant comprising:
receiving process data for one or more process steps in the chemical production process;
receiving consumption data indicating an amount of feedstock associated with producing two or more chemical products;
identifying based on the process data at least one process step producing from the one or more input materials two or more chemical products, wherein the two or more chemical products includes a first chemical product and a second chemical product;
determining based, at least in part, on steering logic a substituted feedstock demand for the first chemical product, if the deviation value for the first chemical product exceeds the target value;
calculating a feedstock demand for the second chemical product based, at least in part, on the substituted feedstock demand for the first chemical product and the consumption data; and
outputting the substituted feedstock demand for the first chemical product and the feedstock demand for the second chemical product.

In another aspect, the disclosure relates to a computer-implemented method for determining an input material demand for two or more chemical products produced in a chemical production process of a production plant comprising:
receiving input material data associated with one or more input materials to the chemical production process;
receiving process data for one or more process steps in the chemical production process;
identifying based on the process data at least one process step producing from the one or more input materials two or more chemical output products, wherein the two or more chemical products includes a first chemical product and a second chemical product;
determining based, at least in part, on a mass allocation calculation a mass fraction feedstock demand for the first chemical product;
determining based, at least in part, on a stoichiometric allocation calculation a stoichiometric-based feedstock demand for the first chemical product;
comparing the mass fraction feedstock demand for the first chemical product with the stoichiometric-based feedstock demand for the first chemical product to determine a deviation value for the first chemical product;
determining if the deviation value for the first chemical product exceeds a target value;
determining based, at least in part, on steering logic a substituted feedstock demand for the first chemical product, if the deviation value for the first chemical product exceeds the target value;
calculating a feedstock demand for the second chemical product based, at least in part, on the substituted feedstock demand for the first chemical product; and
outputting the substituted feedstock demand for the first chemical product and the feedstock demand for the second chemical product.

In another aspect the disclosure relates to a system for determining an input material demand for two or more chemical products produced in a chemical production process of a production plant comprising:
an input configured to receive (i) input material data associated with one or more input materials to the chemical production process and (ii) process data for one or more process steps in the chemical production process;
a processor configured to (i) identify based on the process data at least one process step producing from the one or more input materials two or more chemical output products, wherein the two or more chemical products includes a first chemical product and a second chemical product (ii) determine based, at least in part, on a mass allocation calculation a mass fraction feedstock demand for the first chemical product (iii) determine based, at least in part, on a stoichiometric allocation calculation a stoichiometric-based feedstock demand for the first chemical product (iv) compare the mass fraction feedstock demand for the first chemical product with the stoichiometric-based feedstock demand for the first chemical product to determine a deviation value for the first chemical product (v) determine if the deviation value for the first chemical product exceeds a target value (vi) determine based, at least in part, on steering logic a substituted feedstock demand for the first chemical product, if the deviation value for the first chemical product exceeds the target value and (vii) calculate a feedstock demand for the second chemical product based, at least in part, on the substituted feedstock demand for the first chemical product; and
an output configured to output the substituted feedstock demand for the first chemical product and the feedstock demand for the second chemical product.

In another aspect the disclosure relates to a computer-implemented method for automatically determining an input material(s) demand associated with the production of two or more chemical products, wherein the two or more chemical products(s) are produced by a chemical production network using the input material(s), wherein the chemical production network chemically converts the input material(s) via chemical intermediates to chemical products that exit the chemical production network, the method comprising:
receiving input material data associated with one or more input materials to the chemical production process;
receiving process data for one or more process steps in the chemical production process;
identifying based on the process data at least one process step producing from the one or more input materials two or more chemical output products, wherein the two or more chemical products includes a first chemical product and a second chemical product;
determining based, at least in part, on a mass allocation calculation a mass fraction feedstock demand for the first chemical product;
determining based, at least in part, on a stoichiometric allocation calculation a stoichiometric-based feedstock demand for the first chemical product;
comparing the mass fraction feedstock demand for the first chemical product with the stoichiometric-based feedstock demand for the first chemical product to determine a deviation value for the first chemical product;
determining if the deviation value for the first chemical product exceeds a target value;
determining based, at least in part, on steering logic a substituted feedstock demand for the first chemical product, if the deviation value for the first chemical product exceeds the target value;
calculating a feedstock demand for the second chemical product based, at least in part, on the substituted feedstock demand for the first chemical product; and
outputting the substituted feedstock demand for the first chemical product and the feedstock demand for the second chemical product.

In another aspect the disclosure relates to a computer-implemented method for automatically determining a sustainable input material demand associated with the production of two or more chemical products, wherein the two or more chemical products(s) are produced by a chemical production network using the sustainable input material, wherein the chemical production network chemically converts the sustainable input material via chemical intermediates to chemical products that exit the chemical production network, the method comprising:
receiving input material data associated with one or more input materials to the chemical production process, the one or more input materials including the sustainable input material;
receiving process data for one or more process steps in the chemical production process;
receiving consumption data indicating an amount of at least one of the one or more input materials associated with producing the two or more chemical products;
identifying based on the process data at least one process step producing from the one or more input materials two or more chemical output products, wherein the two or more chemical products includes a first chemical product and a second chemical product;
determining based, at least in part, on a mass allocation calculation and/or an energy allocation calculation a mass and/or energy fraction feedstock demand for the first chemical product;
determining based, at least in part, on a stoichiometric allocation calculation a stoichiometric-based feedstock demand for the first chemical product;
comparing the mass and/or energy fraction feedstock demand for the first chemical product with the stoichiometric-based feedstock demand for the first chemical product to determine a deviation value for the first chemical product;
determining if the deviation value for the first chemical product exceeds a target value;
determining based, at least in part, on steering logic a substituted feedstock demand for the first chemical product, if the deviation value for the first chemical product exceeds the target value, wherein the substituted feedstock demand for first chemical product indicates an amount of sustainable feedstock needed to produce the first chemical product;
calculating a feedstock demand for the second chemical product based, at least in part, on the substituted feedstock demand for the first chemical product and the consumption data; and
outputting the substituted feedstock demand for the first chemical product and the feedstock demand for the second chemical product.

In another aspect the disclosure relates to a computer-implemented method for determining an environmental attribute for two or more chemical products produced in a chemical production process of a production plant comprising:
receiving input material data associated with one or more input materials to the chemical production process;
receiving process data for one or more process steps in the chemical production process;
identifying based on the process data at least one process step producing from the one or more input materials two or more chemical output products, wherein the two or more chemical products includes a first chemical product and a second chemical product;
determining based, at least in part, on a mass allocation calculation a mass fraction feedstock demand for the first chemical product;
determining based, at least in part, on a stoichiometric allocation calculation a stoichiometric-based feedstock demand for the first chemical product;
comparing the mass fraction feedstock demand for the first chemical product with the stoichiometric-based feedstock demand for the first chemical product to determine a deviation value for the first chemical product;
determining if the deviation value for the first chemical product exceeds a target value;
determining based, at least in part, on steering logic a substituted environmental attribute for the first chemical product, if the deviation value for the first chemical product exceeds the target value;
calculating an environmental attribute for the second chemical product based, at least in part, on the substituted environmental attribute for the first chemical product; and
outputting the substituted environmental attribute for the first chemical product and the environmental attribute for the second chemical product.

In yet another aspect disclosed is a computer element, in particular a computer program product or a computer readable medium, with instructions, which when executed on one or more computing node(s) are configured to carry out the steps of any of the methods disclosed herein. In yet another aspect disclosed is a computer element, in particular a computer program product or a computer readable medium, with instructions, which when executed by a processor cause any of the apparatuses disclosed herein to perform any of the methods disclosed herein.

Disclosed is in yet another aspect the use of one or more chemical products(s) associated with the input material demand calculation(s) as provided by any of the methods disclosed herein and/or produced by a chemical production network as provided by any of the methods disclosed herein to produce at least one discrete product or at least one end product associated with the one or more environmental attribute(s). The at least one discrete product or the at least one end product may be an intermediate or end product of a product supply chain. The at least one discrete product or the at least one end product may be based on one or more chemical products(s). The at least one discrete product or the at least one end product may be produced by discrete manufacturing. Disclosed is in yet another aspect a method for producing at least one discrete product or at least one end product associated with the input material demand calculation(s), wherein the target material associated with one or more of the input material demand calculation(s) as provided by any of the methods disclosed herein and/or produced by a chemical production network as provided by any of the methods disclosed herein is provided and/or used to produce the at least one discrete product or at least one end product associated with the one or more environmental attribute(s).

In yet another aspect the present disclosure relates to a computer element with instructions, which when executed on one or more computing node(s) is configured to carry out the steps of the method(s) of the present disclosure or configured to be carried out by the apparatus(es) of the present disclosure.

Any disclosure, embodiments and examples described herein relate to the methods, the systems, apparatuses, chemical products and computer elements lined out above and below. Advantageously, the benefits provided by any of the embodiments and examples equally apply to all other embodiments and examples.

### EMBODIMENTS

The public, regulators, and financial investors are increasingly concerned with the environmental impacts of chemical production processes. Major companies, in turn, have announced ambitious plans to track and manage the environmental impacts associated with the production of their products. When chemical production processes produce two or more co-products, it can be difficult to accurately allocate feedstock demand to the co-products.

Traditionally, feedstock demand is attributed (or allocated) using mass balancing. In this approach, the environmental attributes are allocated according to the mass ratio of the resulting co-products. In many cases, however, the co-products are different materials with different characteristics. The allocation of environmental attributes based on mass ratio does not account for the differentiated characteristics that different materials may have. Thus, traditional allocation schemes such as mass balancing can result in an inaccurate loading of the feedstock demand to co-products that have different characteristics.

An object of the present disclosure is to provide a system and method for more accurately allocating feedstock demand to co-products.

The systems, methods, and apparatuses of the present disclosure enable more accurate determination of feedstock demand in chemical processing and provide chemical products with positive environmental impact through the value chain. By using feedstock demand calculation to determine whether mass allocation method is sufficiently accurate for a process (or process step), the values of the feedstock demand for the co-products can be more accurately calculated. Specifically, for chemical networks that produce more than one chemical product from more than one input material via interconnected, connected and non-connected production chains, the use of feedstock demand logic to determine the feedstock demand for a co-product enables a more accurate calculation of the environmental attribute(s) of the remaining co-product(s) produced in a chemical process. Chemical products may have identifiers which enables the reliable assignment of feedstock demand to the chemical products in line with the physical setup of the chemical production network. This way the environmental impact of the co-products can be made transparent to customers (who may be further processing the co-products). By more accurately allocating environmental attributes to chemical products, the chemical production process may be adjusted to increase efficiency and/or mitigate the environmental impact of the chemical production process.

The systems, methods, and apparatuses of the present disclosure enable more accurate determination of feedstock demand in chemical processing and provide chemical products with positive environmental impact through the value chain. By using feedstock demand calculation to determine whether mass allocation is sufficiently accurate, the values of the feedstock demand for other co-products can be more accurately calculated. Specifically, for chemical networks that produce more than one chemical product from more than one input material via interconnected, connected and non-connected production chains, the use of process measurement data to determine an environmental attribute for a co-product enables a more accurate calculation of the environmental attribute(s) of the remaining co-product(s) produced in a chemical process. Chemical products may have identifiers which enables the reliable assignment of environmental attributes to the chemical products in line with the physical setup of the chemical production network. An “environmental attribute” can be, for example, an environmental impact or measure, a social impact or measure, an environmental compensation measure, a social compensation measure, any calculated impact of a product, precursor product, intermediate or raw material. This way the environmental impact of the co-products can be made transparent to customers (who may be further processing the co-products). By more accurately allocating environmental attributes to chemical products, the chemical production process may be adjusted to increase efficiency and/or mitigate the environmental impact of the chemical production process.

In the following, embodiments of the present disclosure will be outlined by way of examples. It is to be understood that the present disclosure is not limited to said embodiments and/or examples.

Carbon footprint or Product Carbon Footprint (PCF) may refer to the amount of greenhouse gases (GHG) emitted or removed in a production process at a manufacturing facility, expressed as carbon dioxide equivalent. The PCF can be assessed from cradle-to-gate (partial PCF) or from cradle-to-grave (total PCF).

Fossil footprint or Product Fossil Footprint (PFF) may refer to the amount of petrochemical feedstocks (e.g., naphtha, crude oil, coal, and natural gas, or intermediates from feedstocks that, in turn, require a certain amount of naphtha, crude oil, coal, and natural gas) consumed in a production process at a manufacturing facility. PFF may be expressed as kilogram methane per kilogram (or methane equivalent).

Environmental attributes may refer to a property or characteristic related to the environmental impact. Such a property may be a property or characteristic of the input materials and/or of chemical products. The environmental attribute may indicate an environmental performance of one or more material(s) and/or the performance of one or more chemical product(s). The environmental attribute may be produced from properties of the input materials, the chemical production network and/or the chemical products. The environmental attribute may be associated with the environmental impact of one or more material(s) at any stage during the lifecycle of the material or products made of the material. The stages of the material lifecycle may include the stages of providing input material, producing products, such as intermediate products or end products, using products, treating end-of-life products, recycling end-of-life products, disposing end-of-life products, reusing components from end-of-life products or any subset of stages. The environmental attribute may be specified or may be produced from any activity of one or more entities participating at any stage of the lifecycle of one or more material(s) or product(s) made of such material(s).

The environmental attribute may include one or more characteristic(s) that are attributable to environmental or sustainability impact of the material or product. The environmental attribute may include environmental, technical, recyclability, circularity or complementary risk characteristics(s), characteristic(s) associated with the environmental impact of one or more material(s) or product(s).

Environmental characteristic(s) may specify or quantify ecological criteria associated with the products environmental impact. Environmental characteristic(s) may be or may be produced or derived from measurements taken during the lifecycle of one or more product(s). Environmental characteristics may be determined at any stage of the product lifecycle and may characterize the environmental impact of the product for such stage or up to such stage. Environmental characteristic(s) may for example include impact categories such as fossil footprint, carbon footprint, greenhouse gas emissions or global warming potential, primary energy demand, cumulative energy demand, biotic and abiotic resource consumption, air emissions, stratospheric ozone depletion potential, ozone formation, terrestrial and/or marine acidification, water consumption, water depletion, water availability, water pollution, noise pollution, freshwater and/or marine eutrophication potential, human carcinogenic and/or non-carcinogenic toxicity, photochemical oxidant formation, particulate matter formation, terrestrial, freshwater and/or marine ecotoxicity, ionizing radiation, agricultural and/or urban land occupation, land transformation, land use, indirect land use, deforestation, biodiversity, mineral resource consumption, fossil resource consumption, and/or feedstock demand (e.g., sustainable feedstock demand and/or fossil feedstock demand). The environmental impact may specify or quantify a product fossil footprint (PFF) which refers to the amount of petrochemical feedstocks (e.g., naphtha, crude oil, coal, and natural gas, or intermediates from feedstocks that in turn require a certain amount of naphtha, crude oil, coal, and natural gas) consumed in a production process at a manufacturing facility.

Environmental characteristic(s) may be calculated from combinations of one of more environmental characteristics. Environmental characteristic(s) may for example include product or material characteristics related to the production of the material or product like renewable, bio based, vegan, halal, kosher, palm oil-free, natural or the like.

The environmental attribute may be a digital asset associated with the input material(s) or chemical product(s). The environmental attribute may digitally specify the environmental impact of the input material or the chemical product. The environmental attribute may relate to fossil footprint or carbon footprint. The environmental attribute may relate to a renewable, a bio-based and/or a recycled content e.g., of the input material and/or chemical product. The environmental attribute may include a qualitative data point relating to the type of impact e.g., in view of the input material or the chemical product. The environmental attribute may specify a type such as recycled, renewable and/or bio-based. The qualitative data point may be converted to a quantitative measure such as environmental units or balancing units. The environmental attribute may include a quantitate data point relating to the type of impact e.g., in view of the input material or the chemical product, recycled content, renewable content or bio-based content. The environmental attribute may specify recycled, renewable and/or bio-based content.

The environmental attribute may include further environmental characteristics of the input or chemical product.

Calculated product characteristics may refer to Product Fossil Footprint, Product Carbon Footprint, energy consumption, water consumption, crude oil consumption, labor (e.g., person hours associated with producing a product), social burdens (e.g., injuries and/or accidents associated with the production of a product), feedstock demand (including, for example, sustainable feedstock demand and/or fossil feedstock demand) and other product characteristics that can be measured and calculated.

The term “input material” as used in the present disclosure may refer to any good which is bought from suppliers and brought to the production plant. The input material may include starting material used in the production process of the production plant to produce the product.

An input material can be on any step along the value chain like the product described above. This means, the product of the one production plant can be the input material of the other production plant. Input material can also include very fundamental goods like air, water, natural gas, sulfur or salt.

Input material(s) may refer to feedstock(s) for a chemical production plant. In chemical production, feedstock may refer to the raw materials or substances that are used to manufacture a particular chemical product. These materials can be natural resources such as petroleum, natural gas, and coal, or they can be renewable sources such as biomass and plant-based materials. The feedstock is typically converted into a more valuable chemical product through a series of chemical reactions and processes. Feedstocks may refer to petrochemical feedstocks such as naphtha, crude oil, coal, and natural gas, or intermediates from feedstocks that in turn require a certain amount of naphtha, crude oil, coal, and natural gas.

Feedstocks may also refer to sustainable feedstocks such renewable feedstocks and/or recycled feedstocks. A sustainable feedstock refers to the use of raw materials or resources that can be replenished or regenerated naturally over time without causing significant harm to the environment or depleting natural resources. This can involve using renewable resources, such as plant-based feedstocks, or ensuring that non-renewable resources are used in a way that minimizes waste and environmental impact. A renewable feedstock may include feedstocks from agricultural crops (e.g., corn, sugarcane, soybeans, and palm oil that are grown specifically for use as biofuels or other chemical feedstocks), forest and wood products (e.g., sawdust and wood chips), and algae (and other aquatic plants), as well as other sources that may be replenished (approximately) faster than they can be depleted (e.g., bio-naphtha, bio-methane, biogas, etc.). A recyclable feedstock may include feedstocks from plastic wastes and other sources (e.g., pyrolysis, syngas, etc.).

A “production plant” as used in the present disclosure may be any facility which is able to produce any kind of good which is sold to an end customer or further processed in a different production plant. A production plant can be on one single site or on multiple. If the production plant is in multiple sites, these have to be under common control which is typically the case if they belong to the same company or to affiliated companies. Examples for plants are power plants, steel manufacturing plants, oil producing plants, oil refineries, chemical plants, partial oxidation plants, plants for manufacturing pharmaceuticals, plants for manufacturing construction materials, machine manufacturing plants, automobile manufacturing plants, plants for manufacturing textiles, plants for manufacturing furniture, food production plants, plants for manufacturing consumer electronics such as cell phones, plants for manufacturing and/or processing of paper, such as a printing press.

Chemical production networks may include multiple types of production processes for producing different chemical products from input materials. The chemical production network may include a complex production network producing multiple chemical products in multiple production chains. The chemical production network may include connected, interconnected and/or non-connected production chains. The connection may be provided by the fact that a process, an operation and an entry point are located within the same building, or within a common fence, or within any other security or organizational containment that is an indication that the operations are controlled by a company. Connectivity may be provided by a concept called “Scope 1” (cf.

Greenhouse gas protocol, https://ghgprotocol.org/sites/default/files/standards/ghg-protocol-revised.pdf), a definition of organizational boundaries, determining the operations owned or controlled by a company. An indicator of connectedness may be a pipe for delivering and sharing any raw material, intermediate, products, utilities such as steam, water, waste water or a common sewage pipe. The chemical production network may produce from input materials multiple intermediates and from intermediates chemical products. Input material may enter the chemical production network at entry points. Chemical product may leave the production network at exit points.

The chemical production network may comprise one or more entry points at which input materials are provided to the chemical production network. Input material may include fossil material, non-fossil material or both. Fossil input material may include crude oil, natural gas, coal, or derivates of those. Non fossil input material may include renewable material, bio-based material or recycled materials. Input material may include feedstock for a gasification plant, a steam cracker or synthesis gas plant. Input material may include synthesis gas produced from fossil feedstock, non-fossil feedstock or both. Input material may include for example pyrolysis oil from recycled waste, syngas produced from recycled waste, naphtha produced from bio-based material, methane from bio-based material, or combinations thereof. Input material may be provided to at least one gasification plant, steam cracker or synthesis gas plant, or any plant of the production chain for downstream products such as nitrogen, ammonia, methanol, ethylene, propylene, sulfur or the like. Input material may include intermediate chemical products produced elsewhere with fossil and/or non-fossil input materials. Input material may include anorganic materials with mineral origin, salts, metals, glass or the like.

The input material associated with one or more environmental attribute(s) provided to the entry point of the chemical production network may include recycled input materials including, but not limited to, recycled pyrolysis oil, recycled pyrolysis gas, recycled synthesis gas, recycled hydrogen, recycled naphtha, recycled methane, recycled ethane, recycled propane, recycled chemicals or combinations thereof. Recycled chemicals may include, but may not be limited to, recycled ammonia, recycled methanol, recycled ethylene, recycled propylene, recycled benzene, recycled toluene, recycled xylene or combinations thereof. Recycled chemicals may include, but may not be limited to, recycled glass, glass fibres, metals, alloys, recycled polymers, recycled oligomers, recycled monomers, or combinations thereof. In the context provided here recycled input material may include any material that at least in part includes recycled content and/or is at least in part produced from recycled content. The recycled content may be but does necessarily have to be physically and/or chemically traceable. The recycled content can be a calculated property of a product. The recycled content can be conveyed by a chain of custody method such as a mass balance model or a book and claim model or a combination of both models.

The input material associated with one or more environmental attribute(s) provided to the entry point of the chemical production network may include bio-based input materials including, but not limited to, bio-based pyrolysis oil, bio-based pyrolysis gas, bio-based synthesis gas, bio-based hydrogen, bio-based naphtha, bio-based methane, bio-based ethane, bio-based propane, bio-based chemicals or combinations thereof. Bio-based chemicals may include, but may not be limited to, bio-based ammonia, bio-based methanol, bio-based ethylene, bio-based propylene, bio-based benzene, bio-based toluene, bio-based xylene or combinations thereof.

Bio-based chemicals may include, but may not be limited to, bio-based polymers, bio-based oligomers, bio-based monomers or combinations thereof. In the context provided here bio-based input material may include any material that at least in part includes bio-based content and/or is at least in part produced from bio-based content. The bio-based content may be but does necessarily have to be physically and/or chemically traceable. The bio-based content can be a calculated property of a product. The recycled content can be conveyed by a chain of custody method such as a mass balance model or a book and claim model or a combination of both models.

“Recycled content” or “bio-based content” are non-exhaustive examples for calculated environmental attributes of a product.

The chemical production network may include multiple production steps for one or more production chains. The production steps included in the chemical network may be defined by the physical system boundary of the chemical production network. The system boundary may be defined by location or control over production processes. The system boundary may be defined by the site of the chemical production network. The system boundary may be defined by production processes controlled by one entity or multiple entities jointly. The system boundary may be defined by value chain with staggered production processes to an end product, which may be controlled by multiple entities separately. The chemical production network may include a waste collection step, a waste sorting step, a recycling step such as chemical recycling through pyrolysis, a cracking step such as steam cracking, a partial oxidation step such as a synthesis gas plant, a separation step to separate outputs of one process step and further processing steps to convert such outputs to chemical products leaving the system boundary of the chemical production network. The entry points of the chemical production network may be marked by the entry of input materials to the chemical production network. The input materials entering the chemical production network may be used to produce one or more chemical products. The chemical products may leave the physical system boundary of the chemical production network. The exit points of the chemical production network may be marked by the exit of chemical products from the chemical production network.

The chemical product may be produced by the chemical production network to which the input material(s) associated with one or more environmental attribute(s) were provided. The chemical product may be produced by a production chain of the chemical production network to which the input material(s) associated with one or more environmental attribute(s) were provided. The chemical product may be produced from the input material(s) associated with one or more environmental attribute(s).

In an embodiment, determining based, at least in part, on steering logic the substituted feedstock demand for the first chemical product, if the deviation value for the first chemical product exceeds the target value further comprises:
determining if the steering logic includes dedicated production data associated with the first chemical product; and
selecting the substituted feedstock demand for the first chemical product based, at least in part, on the dedicated production data associated with the first chemical product, if the steering logic includes dedicated production data associated with the first chemical product.

In an embodiment, determining based, at least in part, on steering logic the substituted feedstock demand for the first chemical product, if the deviation value for the first chemical product exceeds the target value further comprises:
if the steering logic does not include dedicated production data associated with the first chemical product, determining if the steering logic includes externally sourced production data associated with the first chemical product; and
selecting the substituted feedstock demand for the first chemical product based, at least in part, on the externally sourced production data associated with the first chemical product, if the steering logic includes externally sourced production data associated with the first chemical product.

In an embodiment, determining based, at least in part, on steering logic the substituted feedstock demand for the first chemical product, if the deviation value for the first chemical product exceeds the target value further comprises:
if the steering logic does not include externally sourced production data associated with the first chemical product, determining an input factor associated with the first chemical product; and
selecting the substituted feedstock demand for the first chemical product based, at least in part, on the input factor associated with the first chemical product.

In an embodiment, determining based, at least in part, on steering logic the substituted feedstock demand for the first chemical product, if the deviation value for the first chemical product exceeds the target value further comprises determining whether to apply a correction factor to the substituted feedstock demand for the first chemical product based, at least in part on the steering logic.

In an embodiment, selecting the substituted feedstock demand for the first chemical product comprises selecting a substituted sustainable feedstock demand for the first chemical product.

In an embodiment, calculating the feedstock demand for the second chemical product based, at least in part, on the substituted feedstock demand for the first chemical product comprises selecting a substituted sustainable feedstock demand for the second chemical product based, at least in part, on the substituted feedstock demand for the first chemical product.

In an embodiment, the process data may be gathered through an interface to different production plants, such as different computing or storage resources communicatively connected to the different production plants. The process data may be gathered through an interface to enterprise resource planning systems of different group companies, The process data may be consolidated to identify intermediates produced by one group company and used by a different group company.

In an embodiment, the production plant executes interconnected process steps. The term “interconnected” refers to an embodiment in which at least one process step uses two intermediates of different other process steps or uses one intermediate of different other process steps each producing this intermediate or yields two intermediates which are used in two different other process steps. Hence, the production plant executes interconnected process steps. In some embodiments, the production plant is a chemical production plant executing interconnected process steps. Often, the interconnected process steps are executed in different factories, maybe on different sites, potentially operated by different group companies.

In an embodiment, the process data may be gathered through an interface to different production plants, such as different computing or storage resources communicatively connected to the different production plants. The process data may be gathered through an interface to enterprise resource planning systems of different group companies, The process data may be consolidated to identify intermediates produced by one group company and used by a different group company.

In an embodiment, the input comprises an interface to a consolidation system which collects data from different production plant(s), wherein the consolidation system consolidates the process data to identify intermediates produced by different production plants.

In an embodiment, the output comprises a user interface configured to display the substituted feedstock demand for the first chemical product and/or the feedstock demand for the second chemical product. The user interface may provide a graph to visually represent the feedstock demand associated with the chemical products. In some embodiments, the user interface may illustrate the contributions to the feedstock demand along the production process. In some embodiments, a user may use the user interface to analyze the contributions to the feedstock demand and to monitor, manage, and/or adjust the production process to, for example, minimize the feedstock demand the chemical products.

In an embodiment, the processor is further configured to calculate a feedstock demand for an intermediate produced in a preceding process step and use the feedstock demand for the intermediate as an input for the calculation of the feedstock demand for the first and/or second chemical product. In interconnected production processes, the calculation of the feedstock demand can be facilitated by subdividing it into analogous calculation parts, one for each process step.

In an embodiment, the processor configured to determine based, at least in part, on steering logic a substituted feedstock demand for the first chemical product, if the deviation value for the first chemical product exceeds the target value further comprises a processor to:
determine if the steering logic includes dedicated production data associated with the first chemical product; and
select the substituted feedstock demand for the first chemical product based, at least in part, on the dedicated production data associated with the first chemical product, if the steering logic includes dedicated production data associated with the first chemical product.

In an embodiment, the processor configured to determine based, at least in part, on steering logic a substituted feedstock demand for the first chemical product, if the deviation value for the first chemical product exceeds the target value further comprises a processor to:
if the steering logic does not include dedicated production data associated with the first chemical product, determine if the steering logic includes externally sourced production data associated with the first chemical product; and
select the substituted feedstock demand for the first chemical product based, at least in part, on the externally sourced production data associated with the first chemical product, if the steering logic includes externally sourced production data associated with the first chemical product.

In an embodiment, the processor configured to determine based, at least in part, on steering logic a substituted feedstock demand for the first chemical product, if the deviation value for the first chemical product exceeds the target value further comprises a processor to:
if the steering logic does not include externally sourced production data associated with the first chemical product, determine an input factor associated with the first chemical product; and
select the substituted feedstock demand for the first chemical product based, at least in part, on the input factor associated with the first chemical product.

In an embodiment, the computer-implemented method for determining a feedstock demand for two or more chemical products produced in a chemical production process of a production plant further comprises:
determining if the first chemical product and/or the second chemical product contain hydrogen with a mass share above a threshold value; and
determining based, at least in part, on an energy content allocation calculation an energy content feedstock demand for the first chemical product, if the first chemical product and/or the second chemical product contain hydrogen with a mass share above the threshold value.

### BRIEF DESCRIPTION OF THE DRAWINGS

In the following, the present disclosure is further described with reference to the enclosed figures. The same reference numbers in the drawings and this disclosure are intended to refer to the same or like elements, components, and/or parts.

FIG. 1 illustrates an example of a chemical production network producing one or more chemical product(s) from one or more input material(s) in connection with an operating system including feedstock demand calculation logic.

FIG. 2 illustrates an example of a chemical production network producing one or more chemical product(s) from one or more input material(s) in connection with an operating system including feedstock demand calculation logic to calculate feedstock demands.

FIG. 3 illustrates an example of a part of a chemical production network producing multiple chemical products(s) from fossil and non-fossil input material(s).

FIG. 4. illustrates selected aspects of a chemical production network according to the disclosure.

FIG. 5. is a flow diagram illustrating selected aspects of feedstock demand calculation logic according to an embodiment of the disclosure.

FIG. 6 is a flow diagram illustrating selected aspects of feedstock demand calculation with steering logic according to an embodiment of the disclosure.

FIG. 7 is a flow diagram illustrating selected aspects of feedstock demand calculation with steering logic according to an embodiment of the disclosure.

FIG. 8 illustrates an example of a feedstock demand calculation according to an embodiment of the invention.

FIG. 9 is a block diagram illustrating selected aspects of an electronic system with feedstock demand logic according to an embodiment of the disclosure.

FIG. 10 shows a schematic view of a consolidation system for consolidating data in a chemical production network.

### DETAILED DESCRIPTION

The present disclosure is in the field of computer-implemented systems and methods for determining and calculating the feedstock demand (e.g., sustainable input material requirement, fossil input material requirement, etc.) of products made in the chemical production processes of chemical production plants.

The disclosed system and process can be applied to a wide variety of products that are made from input materials, such as chemical products or precursor products. The term “product” may refer to any commodity that can be sold to others at any point in the value chain. This may include end products for end users (e.g., cars, paints, toys, or medicines). This may also include goods that are typically sold to other companies for further processing (e.g., steel parts for machinery, plastic pellets for extrusion, or chemical compounds such as acrylic acid to make superabsorbents for diapers). This may also include goods that are very early in the value chain such as crude oil fractions (e.g., naphtha), agricultural products (e.g., soybeans), or purified sand for glass production.

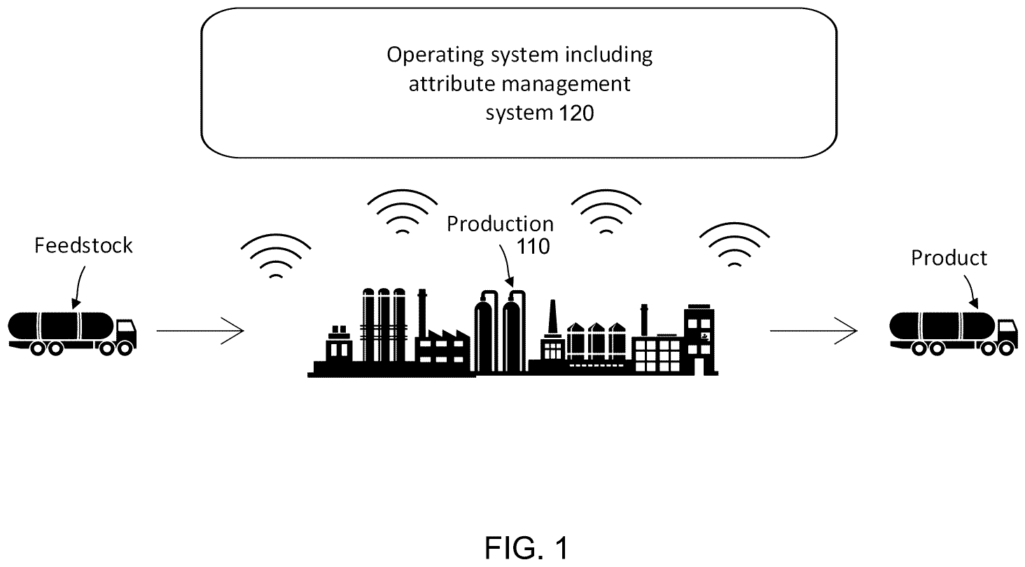

FIG. 1 illustrates an example of a chemical production network 110 producing one or more chemical product(s) from one or more input material(s) in connection with an operating system including an attribute management system 120. For producing one or more chemical product(s) different input materials (feedstocks) may be provided as physical inputs from material providers or suppliers. The chemical products produced from the input materials may have one or more properties related to the environmental impact of the input materials or the chemical products produced from the input materials, that may be signified by the environmental attributes.

The chemical production network may include multiple interlinked processing steps. The chemical production network may be an integrated chemical production network with connected or interconnected production chains. The chemical production network may include multiple different production chains that have at least one intermediate product in common. The chemical production network may include multiple stages of the chemical value chain. The chemical production network may include the producing, refining, processing and/or purification of gas or crude oil. The chemical production network may include a stream cracker, or a syngas plant connected to multiple production chains that output chemical products from the effluent of the steam cracker or syngas plants. The chemical production network may include multiple production chains that produce from one or more input material(s) chemical products that exit the chemical production network. The chemical production network may include multiple tiers of a chemical value chain. The chemical production network may include physically connected or interconnected supply chains and/or production sites. The production sites may be at the same location or at different locations. In the latter case, the production sites may be connected or interconnected by means of dedicated transportation systems such as pipelines, supply chain vehicles, like trucks, ships or other cargo transportation means.

The chemical production network may chemically convert input materials via chemical intermediates to one or more chemical product(s) that exit the chemical production network. The chemical production network may convert input material(s) by way of chemical conversion to one or more chemical product(s).

The input material(s) may be fed into the chemical production network at any entry point. The input material(s) may be fed into the chemical production network at the start of the chemical production network. Input materials may, for example, make up the feedstock of a steam cracker. The input material may include a bio-based, a recycled and/or a fossil input material for the manufacture of chemical intermediates and chemical products.

The chemical production network may include multiple production steps. The production steps included in the chemical network may be defined by the system boundary of the chemical production network. The system boundary may be defined by location or control over production processes. The system boundary may be defined by the site of the chemical production network. The system boundary may be defined by production processes controlled by one entity or multiple entities jointly. The system boundary may be defined by a value chain with staggered production processes to an end product, which may be controlled by multiple entities separately. The chemical production network may include a waste collection and sorting step, a recycling step such as pyrolysis, a cracking step such as steam cracking, a separation step to separate outputs of one process step and further processing steps to convert such outputs to a chemical product leaving the system boundary of the chemical production network.

The operating system 120 of the chemical production network may monitor and/or control the chemical production network based on operating parameters of the different processes. One process step monitored and/or controlled may be the feed of input materials or the discharge of chemical products. Operating system 120 may also monitor and/or determine the feedstock demand for one or more of the chemical products produced by the chemical production network. Another process step monitored and/or controlled may be the allocation of environmental attributes to chemical products produced via the chemical production network. Yet another process step monitored and/or controlled may be the registration of environmental attributes associated with input material(s) entering the system boundary of the chemical production network. Yet another process step monitored and/or controlled may be the management of environmental attributes associated with input material(s) and chemical product(s) of the chemical production network.

The operating system may be configured to access data related the inputs material(s), the process(es) and/or the chemical product(s) produced by the chemical production network. For example, the operating system may be configured to access input material data for the feedstocks used in the chemical production network. The feedstocks may include fossil feedstock(s) and/or sustainable feedstock(s). A sustainable feedstock may include a bio-based, a recycled and/or a fossil input material. The operating system may be configured to receive consumption data indicating an amount of input material (e.g., sustainable feedstock, fossil feedstock, etc.) associated with producing one or more chemical products in the chemical production network. The term “consumption data” refers to historical production data indicating the feedstock consumption associated with the production of chemical products. The consumption data may include average consumptions over time (e.g., a 1-year average consumption, 5-year average consumption, etc.) to level out seasonal and other fluctuations related to the chemical production processes. Operating system 120 may be configured to access process data. The process data may comprise the digital representation of one or more process step(s) of one or more production process(es). Such representation may include or may be associated with information about input materials and process steps in one or more production plant(s).

The operating system may be configured to convert a recycled, renewable, or bio-based content of the one or more input material(s) used in the chemical production network to balancing units.

The operating system may be configured to allocate the balancing units to at least one balancing account associated with the recycled or bio-based content of the input materials. The operating system may be configured to allocate at least a part of the balancing units from the at least one balancing account to the at least one chemical product.

The operating system may be configured to manage balancing units related to the input and chemical products produced by the chemical production network. In particular, the operating system may be configured to determine balancing units associated with the use of input materials impacting the environmental property/attribute of the chemical products produced by the chemical production network. The operating system may be configured to determine balancing units associated with the chemical product(s) and the environmental property of the chemical product(s). This way the operating system may be configured to allocate balancing units to balancing accounts or to deallocate balancing units from the balancing accounts. The balancing units may be viewed as a credit that may be deposited in an account (e.g., a digital inventory) or deducted from an account related to the input and chemical products of the chemical production network.

The operating system may be configured to register inbound environmental attributes, to convert the inbound environmental attributes to balancing units (and back as needed), and/or to assign outbound environmental attributes and to manage inbound allocation as well as outbound assignment.

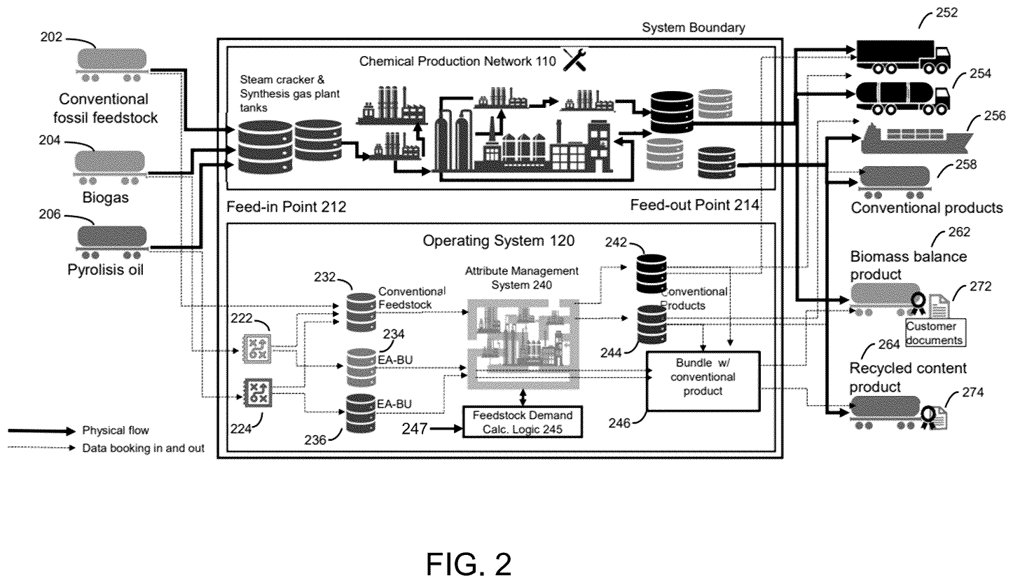

FIG. 2 illustrates an example of a chemical production network 110 producing one or more chemical product(s) from one or more input material(s) in connection with an operating system 120 including an attribute management system 240 to manage two or more environmental attributes and feedstock demand calculation logic 245 to calculate feedstock demand for co-products (when a production process produces two or more co-products). Chemical production network 110 is described above with reference to FIG. 1.

Operating system 120 is a digital operating system configured to collect, store, manage and interpret a wide range of production, stoichiometric and/or business data for chemical production network 110. Operating system 120 may be part of an Enterprise Resource Planning (ERP) system. Alternatively, operating system 120 may be partly implemented in an ERP system and partly implemented in one or more additional systems coupled with an ERP system. Operating system 120 may also be implemented in one or more systems outside of an ERP system.

Input materials 202-206 are provided to chemical production network 110 at the feed-in point 212. The input materials may include conventional fossil feedstock 202 (e.g., naphtha) as well as sustainable input materials 204-206. The sustainable input materials 204-206 may include renewable input materials (such as biogas and/or bio-naphtha) and/or recycled input materials (e.g., pyrolysis oil). After they are delivered to chemical production network 110, the conventional input materials 202 and the sustainable input materials 204-206 may be combined (e.g., by being fed into the same tank) as they enter the chemical production process.

Input material data for sustainable input material 204 is provided to operating system 120 at 222. Similarly, input material data for sustainable input material 206 is provided to operating system 120 at 224. For example, the goods receipt (and/or a BOM and/or a chemical production recipe) including the input material data for each of the sustainable input materials may be electronically provided to operating system 120 when sustainable materials 204-206 are delivered to chemical production network 110. Operating system 120 may receive input material data 222-224 through an interface to a local or a remote database or an ERP system, in particular its supply chain module, or any computing system or apparatus, such as a centralized or decentralized computing system or apparatus including processing and storage. The input material data for each input material may hence be gathered from an ERP system or any computing system or apparatus, such as a centralized or decentralized computing system or apparatus including processing and storage. In some cases, the input material data of each input material is gathered through an interface to more than one database. It therefore may be necessary to convert the information retrieved from different databases into a single format to allow further processing. In particular, the input material data obtained from databases may be attributed to the input material via the identification of an input material in the database that has to be translated to the identification of the input material of the process data used in the process according to the present disclosure.

Operating system 120 may initiate a virtual production step after it receives the input material data for sustainable materials 204-206. Virtual production refers to receiving input material data for a sustainable input material and producing environmental attributes (based on the sustainable input material) and also “producing” conventional input material data (e.g., data describing the corresponding amount and/or value of the conventional input material).

For example, operating system 120 may initiate a virtual production process when it receives input material data for sustainable input material(s) (e.g., 222-224). Using input material data 222-224, the virtual production process may parse the input material data and apply a corresponding recipe. For example, the virtual production process may determine the volume (or mass) and type of sustainable input material that was received from the input material data. It may then apply virtual production step(s) to the sustainable input material 222-224. The virtual production step(s) may “produce” both environmental attributes (e.g., 234-236) and conventional input material 232. The amount of conventional input material 232 (virtually) produced may be equal to the amount of sustainable input material 204-206.

After the virtual production process, operating system 120 may credit digital inventory (which may also be referred to as a virtual balancing account) 232 with the amount of conventional feedstock that was created by the virtual production process(es). Operating system 120 may also convert the environmental attributes to balancing units and allocate or credit those balancing units to digital BU inventories (or virtual balancing accounts) 234-236. The conversion may include a conversion factor that takes account of the chemical difference between fossil-based input materials, such as naphtha and methane, and non-fossil input materials, such as pyrolysis oil. The conversion factor may relate to the lower heating value of the pyrolysis oil in relation to the lower heating value of naphtha or methane. The conversion factor may include the ratio of the lower heating value of pyrolysis oil to naphtha or methane. This way the chemical difference between the fossil and the renewable input material can be taken into account.

Digital inventories 234-236 may determine and track both the amount (e.g., volume and/or mass) and the value of sustainable input material 204-206, respectively. For example, operating system 120 may parse input material data 222 to determine the amount of sustainable input materials 204 that was received. Similarly, operating system 120 may parse input material data 224 to determine the amount of sustainable input material 206 that was received. Operating system 120 may then credit digital inventories 234 and 236, respectively, with the amount of sustainable input materials that were received.

Operating system 120 may also determine a value associated with the balancing units it credits to digital inventories. For example, operating system 120 may compute the difference in cost between sustainable input materials 204-206 and corresponding equivalent fossil input materials to determine the value of the balancing units. Operating system 120 may use average price, actual price, market price or other suitable values to determine the cost of the equivalent amount of fossil input materials. Operating system 120 stores and tracks the amounts and values corresponding to sustainable input materials in digital inventories 234-236. For example, the balancing units stored in digital inventories 234-236 may include the amount and/or value information corresponding to sustainable inputs 204-206.

Operating system 120 includes amalgamating system 246 to create sustainable chemical products by combining balancing units with conventional products. For example, operating system 110 may process an order for a product 252-264. If the customer purchased a conventional chemical product 252-258, operating system 120 may process the purchase using conventional product digital inventories 242-244.

If, however, the customer purchased a sustainable chemical product, operating system 120 may direct amalgamating system 246 to combine balancing units from digital inventories (or virtual balancing accounts) 234-236 with conventional products from digital inventories 242-244.

Amalgamating system 246 may generate a digital asset (which may or may not be incorporated into another record such as a BOM and/or sales record) 272-274 that defines (or specifies) a sustainable product from the combination of balancing units and conventional products. For example, amalgamating system 246 may create a sustainable product by combining conventional products (from 242-244) with environmental attributes from digital inventory 234 as shown by 272. Similarly, amalgamating system 246 may create a circular product by combining conventional products (from 242-244) with environmental attributes from digital inventory 236 as shown by 274. Thus, operating system 120 enables chemical production network 110 to efficiently create multiple sustainable products from multiple input materials including sustainable input materials that are combined with fossil input materials in a large interconnected chemical production network.

Consumption data is provided to operating system 120 at 247. For example, the historical production data indicating the feedstock consumption (e.g., consumption of input materials 202-206) associated with producing chemical products (e.g., 252-264) in chemical production network 110 may be electronically provided to operating system 120. Operating system 120 may receive consumption data 247 through an interface to a local or a remote database or a consolidation system, an ERP system or any computing system or apparatus, such as a centralized or decentralized computing system or apparatus including processing and storage.

The input consumption data may be gathered from a consolidation system, an ERP system or any computing system or apparatus, such as a centralized or decentralized computing system or apparatus including processing and storage. In some cases, the consumption data for one or more products 252-264 is gathered through an interface to more than one database. It therefore may be necessary to convert the information retrieved from different databases into a single format to allow further processing. In particular, the consumption data obtained from databases may be attributed to the input material (e.g., sustainable feedstocks such as 204-206) via the identification of an input material in the database that has to be translated to the identification of the input material of the process data used in the process according to the present disclosure.

Operating system 120 includes feedstock demand calculation logic 245 to calculate the feedstock demand for one or more of the chemical products (e.g., 252-264 and/or intermediates, by-products, and/or side streams for 252-264) produced by chemical production network 110. For example, feedstock demand calculation logic 245 may initially check process data for a process step (or process) to determine if it produces two or more co-products. If so, then feedstock demand calculation logic 245 may determine whether to calculate the feedstock demand for the co-products using (1) attribution as determined by mass or (2) attribution as determined by energy. For example, feedstock demand calculation logic 245 may check to see if one of the co-products contains hydrogen with a mass share above a threshold. If one of the co-products does contain hydrogen with a mass share above a threshold, then feedstock demand calculation logic 245 may calculate the feedstock demand for the co-products using attribution as determined by energetic content. If the co-products do not contain hydrogen with a mass share above a threshold, then feedstock demand calculation logic 245 may calculate the feedstock demand for the co-products using attribution as determined by mass.

If feedstock demand calculation logic 245 selects attribution as determined by mass, it may then check the result to see if it deviates from a stoichiometric allocation by more than a target value.

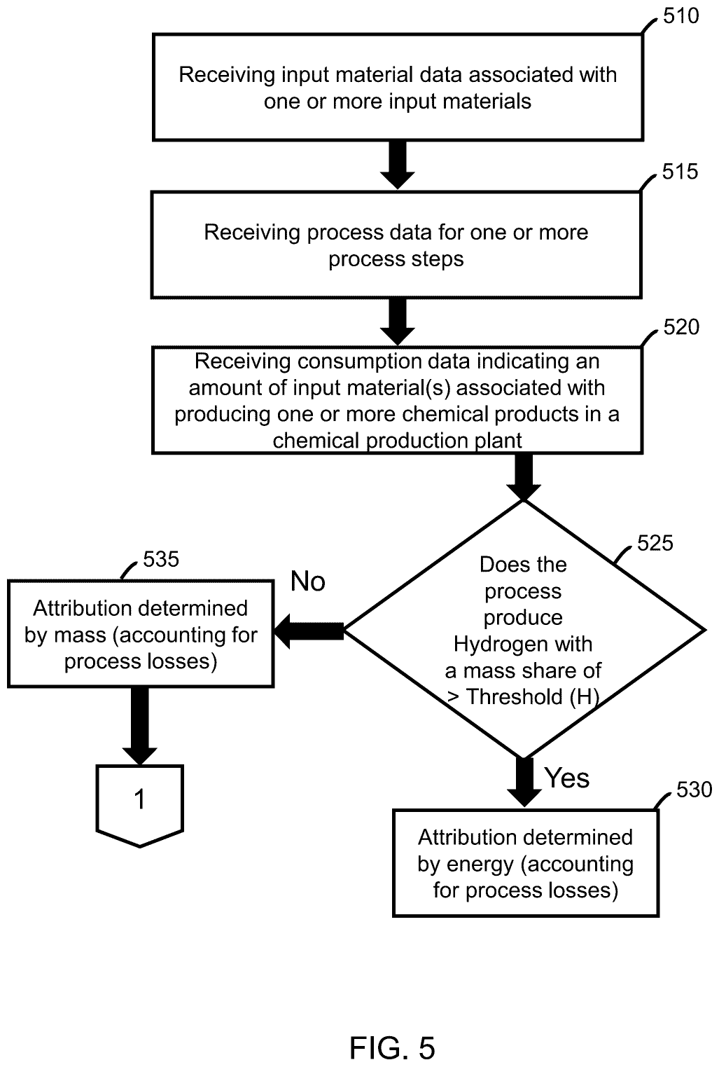

If so, then feedstock demand calculation logic 245 may apply a substitution approach to determine the feedstock demand for at least one of the co-products. As is further described below with reference to FIGS. 5-9, feedstock demand calculation logic 245 may then use consumption data 247 and the value(s) from the substitution approach to calculate the feedstock demand for the other co-product(s).

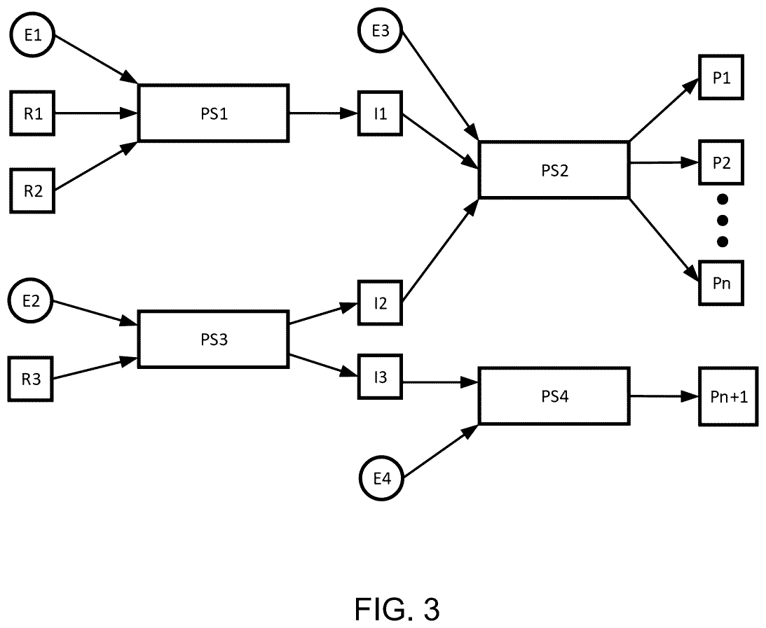

FIG. 3 illustrates an example of a part of a chemical production network producing multiple chemical products from fossil and non-fossil input material(s). The input materials are denoted as R1, R2 and R3, the products are denoted as P1-Pn+1. The intermediates (i.e., all goods which are neither input materials nor products) are denoted as 11, 12 and 13. The energy required for each production process is denoted as E1, E2, E3 and E4. The process steps are denoted as PS1, PS2, PS3 and PS4. Input materials R1 and R2 are processed in a first process step PS1 to produce intermediate 11 using the energy E1. In the next process step PS2, intermediate 11 is processed with intermediate 12 using the energy E3 to arrive at product P1, P2 and Pn. Intermediate 12 is also made within the same production plant in process step PS3 by processing input material R3 using the energy E2. In process step PS3, another intermediate 13 is obtained which can be further processed in another process step PS4 using energy E4 to arrive at product Pn+1. It can easily be recognized that the input materials R1, R2 and R3 as well as the energies E1, E2 and E3 have an impact on the environmental attributes of products P1, P2 and Pn. In addition, however, the usage of 13 may have an impact because, if the demand for product Pn+1 changes, either the input of 13 cannot be used completely because of too low demand for product Pn+1, a higher percentage of the environmental attribute of R3 and the environmental impact due to E2 may have to be attributed to 12 and consequently to P1, P2 and/or Pn. Therefore, it is usually necessary to provide complete information about all input materials and all process steps in a production plant, at least in case there are connections between different chains of process steps from input materials to the products. The process data may comprise the digital representation of one or more process step(s) of one or more production process(es). Such representation may include or may be associated with information about input materials and process steps in one or more production plant(s), in case there are connections between different chains of process steps from input materials to the products.

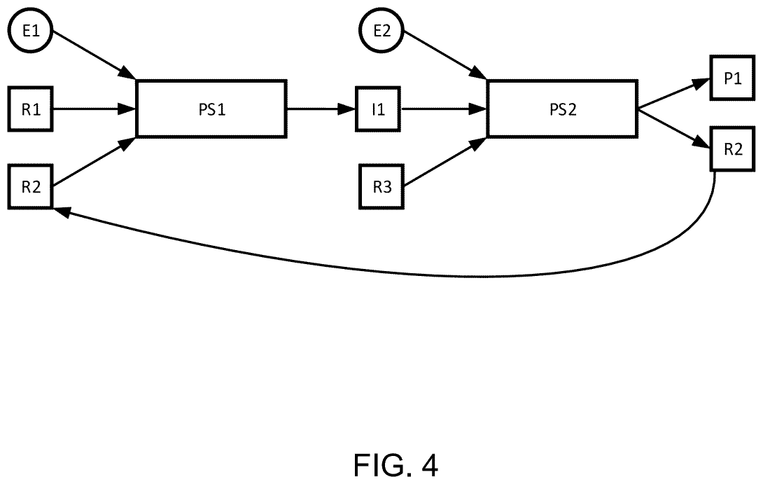

FIG. 4 shows another example which can particularly occur in the chemical industry. Input materials R1 and R2 are processed in a first process step PS1 to produce intermediate 11 using the energy E1. In the next process step PS2, intermediate 11 and input material R3 are processed using the energy E2 to arrive at product P1 while the reagent R2 is also obtained. R2 can be reused in process step PS1, so a cycle is formed. In this situation, the process data may contain information on how much of reagent R2 is used from a supplier and how much recycled reagent R2 obtained in process step PS2 is used.

FIG. 5 is a flow diagram illustrating selected aspects of calculating the feedstock demand for two more or co-products according to an embodiment of the disclosure. An operating system (such as operating system 120 shown in FIG. 2) receives input material data associated with one or more input materials at 510. The input material data may be obtained or derived from information provided by the input material supplier (e.g., via a bill of materials, a digital product passport, a digital twin, etc.). In some cases, the input material data may be from public or private databases. Different suppliers may provide the same input material with different input material data due to differences in the material's production process or logistics. Therefore, the input material data may be gathered for each supplier together with an identifier of the supplier.

This information can then be used to calculate the environmental attribute of a particular input material depending on how much of the input material is used from which supplier. Priority rules may be defined for cases when environmental attributes for one input material are available from multiple sources. Priority rules may depend on data quality or certification of the source.

The result may be taken into account when determining and/or calculating the feedstock demand (and/or an environmental attribute) for a chemical product. The input material data is typically gathered through an interface. The input material data may be received through an interface to a local or a remote database or an ERP system, in particular its supply chain module, or any computing system or apparatus, such as a centralized or decentralized computing system or apparatus including processing and storage. The input material data may hence be gathered from an ERP system or any computing system or apparatus, such as a centralized or decentralized computing system or apparatus including processing and storage.

In some cases, the input material data may be gathered through an interface to more than one database. In such cases, it may be necessary to convert the information retrieved from different databases into a single format to allow further processing.

The operating system receives process data for one or more process steps in the chemical production process at 515. The process data may comprise information about the process steps from the required input materials to the product. A “process step” in the context of the present disclosure refers to a specific stage or operation in the overall process of producing a chemical product which cannot be reasonably separated in time or space. It may include one or more chemical reactions or physical processes such as mixing, distillation, filtration, or drying.

Typically, all acts of one process step take place in one building using certain dedicated equipment. The production process of the production plant may include one or more process step(s). The process data may include a digital representation of the one or more process step(s) of the production process.

The process data can comprise information regarding which reagents are required at which amounts for each process step. The process data may comprise the digital representation of one or more process step(s) of the production process and such representation may include or may be associated with the information regarding which reagents are required at which amounts for the one or more process step(s). A “reagent” can be an input material or an intermediate of a different process step. An “intermediate” refers to a good, such as a substance, which is neither an input material nor a product, but is made from input materials or earlier intermediate and is processed further into other intermediates and finally into the product. Each process step may require one or more reagent(s). The “amount” of a reagent refers to the mass, the volume or the number of pieces per intermediate or product depending on the nature of the reagent, intermediate and/or product. The mass is typically used for bulk goods, such as metals. The volume is typically used for liquids, such as water or glycerol. The number of pieces is typically use for individualized goods, such as screws or plastic pieces. All these units are given per unit of intermediate or product, for example 0.5 kg of reagent 1 per kg of product.

The process data can comprise information about which by-products are obtained in which amount for one or more process step(s). The process data may comprise the digital representation of one or more process step(s) of the production process and such representation may include or may be associated with the information relating to which by-products (or co-products) are obtained in which amount for respective process step(s). Some process steps may not produce any by-products, such as the assembly of steel parts. In this case, the process data does not comprise information about by-products. However, many process steps produce by-products (or co-products).

A distinction may be drawn between a by-product and a “residue.” In the context of the present disclosure a residue refers to any good which is unavoidably obtained in a process step but cannot be used in a different process step. Sometimes, a residue can be recycled, i.e. be subjected to another process step or multiple process steps to obtain an input material or an intermediate which can be used as a reagent in a process step. However, in some cases, there is no economically feasible use for the residue. In this case, the residue has to be disposed. It can, for example, be burned in an incinerator. If the incineration is part of the production plant, the thermal and/or electrical energy regained may preferably be taken into account. It may also be transferred to a sewage plant to be flared or, in the case of carbon dioxide, it may also be stored in emptied gas fields.

The process data can comprise the information regarding which intermediate or intermediates are obtained in each process step and at which yield. The process data may comprise the digital representation of one or more process step(s) of the production process and such representation may include or may be associated with the information regarding which intermediate or intermediates are obtained in the one or more process step(s) and at which yield. The “yield” in the context of the present disclosure refers to the percentage of outcome from a particular process step relative to the theoretical maximum. If the yield is 100%, for example if ingredients are mixed into a formulation, the process data does not have to comprise information about the yield. However, the yield can be below 100% if there are losses in a process step. In chemical reactions, the yield is typically below 100%, because of side reactions and losses upon purifications. In other processes, yields can also be below 100%, for example if steel parts are cut or drilled, there may be a certain percentage that are defective and the defective goods may cause a loss unless they can be reused. In chemistry, defect goods may be referred to as off-spec material which may be reproduced, sold as “secunda” or treated as waste or residue.

The process data can comprise information about any direct environmental impact by the process step (e.g., petrochemical feedstock consumption, greenhouse gas emission, etc.).

These environmental impacts may stem from a chemical reaction of the input materials which consumes petrochemical feedstock(s). These environmental impacts may also stem from a chemical reaction of the input materials which either contains greenhouse gases or generates greenhouse gases during the process step, for example, by heating. A typical example is cement production in which carbon dioxide evolves from heating the input materials, in particular from heating limestone. The process data may comprise the digital representation of one or more process step(s) of the production process and such representation may include or may be associated with information about direct environmental impact(s) by respective process step(s). The information about direct environmental impacts may contain, for example the information about which (and the amount(s) of) petrochemical feedstocks are consumed and/or which greenhouse gases are emitted (and the associated amounts). The amount can be given relative to the amount of input materials or relative to the amount of product or intermediate of the respective process step. The latter can be derived from the former by multiplying with the yield of the process step.

In the easiest case, one or multiple input materials are processed in one process step to arrive at the product. An example could be that certain cables and plugs are the input materials which are assembled to form a cable tree as a product which is sold to car manufacturers. In most cases, however, the production processes are more complicated. Multiple input materials are processed into various intermediates which are processed into various products, wherein one input material can be used to produce more than one intermediate and one intermediate may be used to produce more than one product. In such a situation, the final environmental attribute of one product may depend on the environmental attributes of other products produced at the production plant. Hence, typically the process data comprise the information regarding which reagents are required at which amounts for each process step for all products having at least one reagent or intermediate in common.

The operating system receives consumption data for one or more co-products produced by the chemical production process at 520. The term “consumption data” may refer to the quantitative data that indicates the amount of feedstocks (or input materials or raw materials) consumed during the production process to make a specific chemical product. This data may include the amount of each feedstock consumed, such as sustainable feedstock and/or fossil feedstock.

Consumption data is critical in determining the efficiency and cost-effectiveness of the production process, as well as identifying potential inefficiencies or waste in the process. It can also be used to optimize the production process, reduce costs, and minimize the environmental impact of chemical production. The consumption data may include (or may be derived form) a digital representation of the amount of feedstock(s) consumed to make two more chemical products in a chemical production process.

In some embodiments of the disclosure, the consumption data is based on historical production data indicating the feedstock consumption associated with the production of chemical products.

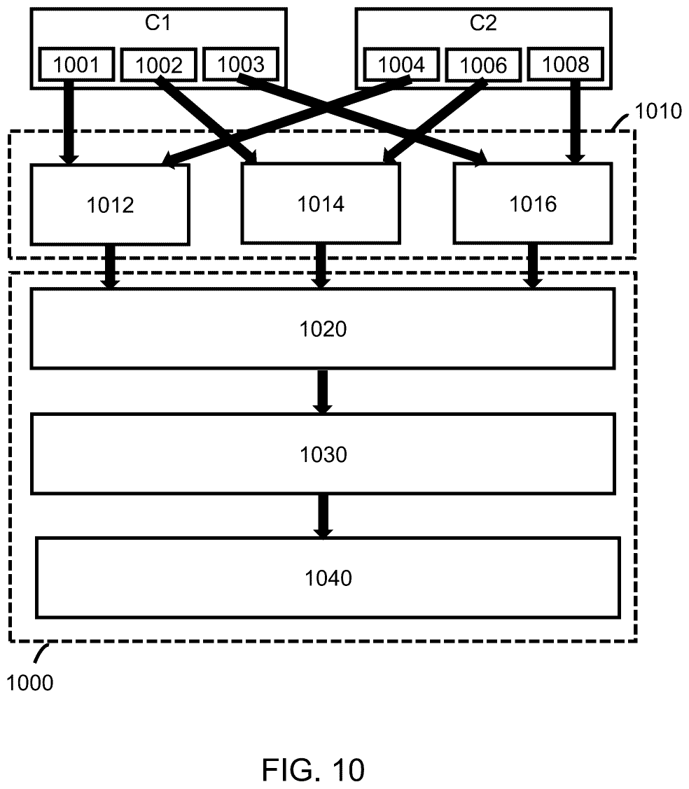

The consumption data may be specific to a site, a legal entity, a production process, and/or the country in which the production process occurred. The consumption data may include average consumptions over time. For example, the consumption data may provide the 1-year average consumption, 5-year average consumption, and/or the 10-year average consumption for a chemical product. The average consumption data may level out seasonal and other fluctuations related to the chemical production processes. A consolidation system (e.g., consolidation system 1010 shown in FIG. 10) may gather the consumption data from different production plants, sites, legal entities, etc. The consolidation system may process and structure the consumption data for use by the operating system.

The consumption data may comprise the digital representation of the required (sustainable and/or fossil) feedstock(s) required to make a co-product in a chemical process that produces two or more co-products. The consumption data may contain, for example, information about which (and the amount(s) of) feedstocks that are consumed to produce the co-product. The amount can be given relative to the amount of input materials or relative to the amount of product or intermediate of the respective process step. The latter can be derived from the former by multiplying with the yield of the process step.

The consumption data may be received through an interface to a local or a remote database or an ERP system or any computing system or apparatus, such as a centralized or decentralized computing system or apparatus including processing and storage. The consumption data may hence be gathered from an ERP system or any computing system or apparatus, such as a centralized or decentralized computing system or apparatus including processing and storage. In some cases, the consumption data may be gathered through an interface to more than one database. In such cases, it may be necessary to convert the information retrieved from different databases into a single format to allow further processing.

The operating system may parse the process data received at 515 to determine if the production process (or process step) will produce two or more co-products (which, in the case of two co-products may be referred to as a first chemical product and a second chemical product). If so, the operating system determines a feedstock demand calculation method to apply at 525. For example, in some embodiments of the disclosure, the operating system initially determines whether to calculate the feedstock demand for the two or more co-products based on mass attribution or energy content attribution. Attribution by mass refers to the method of allocating the amount of feedstock used in the production process to each co-product based on their respective masses. This method involves determining the mass of each co-product produced in the process and then dividing the amount of feedstock(s) used in the process proportionally based on the mass of each co-product.

For example, consider a chemical production process:
the chemical product process uses 1000 kg of feedstock to produce two co-products: Product A and Product B;
the feedstock consists of 60% fossil feedstock and 40% sustainable feedstock (e.g., biomass); and
the production process results in 600 kg of Product A and 400 kg of Product B.

According to attribution by mass, to determine the amount of sustainable feedstock used in the production of each co-product, you would first calculate the mass of each co-product produced as a percentage of the total mass of both co-products:
Product A mass=600 kg/(600 kg+400 kg)=60%
Product B mass=400 kg/(600 kg+400 kg)=40%

Next, you would calculate the amount of sustainable feedstock used in the production of each co-product as a percentage of the total sustainable feedstock used:
Sustainable feedstock used for Product A=40% of 1000 kg×60%=240 kg
Sustainable feedstock used for Product B=40% of 1000 kg×40%=160 kg

Therefore, in this example, 240 kg of sustainable feedstock would be attributed to Product A and 160 kg of sustainable feedstock would be attributed to Product B.

Attribution by energy content refers to the method of allocating the amount of feedstock used in the production process to each co-product based on their respective energy content. This method involves determining the energy content of each co-product produced in the process and then dividing the amount of feedstock used in the process proportionally based on the energy content of each co-product.

For example, if a chemical production process uses 1000 GJ of feedstock to produce two co-products: Product A and Product B. Assume the feedstock consists of 60% fossil feedstock and 40% sustainable feedstock (e.g., biomass), with the LHV (Lower Heating Value) of the fossil feedstock being 40 GJ/tonne and the LHV of the sustainable feedstock being 20 GJ/tonne. Also assume the production process results in 600 GJ of Product A and 400 GJ of Product B.

To determine the amount of sustainable feedstock used in the production of each co-product, you would first calculate the total energy content of the feedstock used:
Total energy content of feedstock=(60%×40 GJ/tonne)+ (40%×20 GJ/tonne)=32 GJ/tonne.

Next, you would calculate the amount of sustainable feedstock used in the production of each co-product as a percentage of the total energy content of the feedstock used:
Energy content of Product A=600 GJ
Energy content of Product B=400 GJ
Total energy content of both co-products=1000 GJ
Sustainable feedstock used for Product A=40% of (600 GJ/32 GJ/tonne)×20 GJ/tonne=187.5 tonnes
Sustainable feedstock used for Product B=40% of (400 GJ/32 GJ/tonne)×20 GJ/tonne=125 tonnes.

Returning to step 525, the operating system may parse the process data received at 515 to determine whether to calculate the feedstock demand for the process (or process step) by mass attribution or energy content attribution. For example, the operating system may identify based on the process data at least one process step producing from the one or more input materials two or more chemical products, wherein the two or more chemical products includes a first chemical product and a second chemical product. In some embodiments of the disclosure, the operating system parses the process data to determine whether the first chemical product and/or the second chemical product has a mass share of hydrogen greater than a threshold value. In some embodiments of the disclosure, the threshold value may be 1% (share of hydrogen by mass). In other embodiments, a different threshold value may be used.

If the mass share of hydrogen is greater than a threshold value, then the operating system may calculate the feedstock demand for the co-product(s) by energy content (at 530). If, the mass share of hydrogen is less than a threshold value, however, then the operating system calculates the feedstock demand for the co-product(s) by mass attribution (at 535).

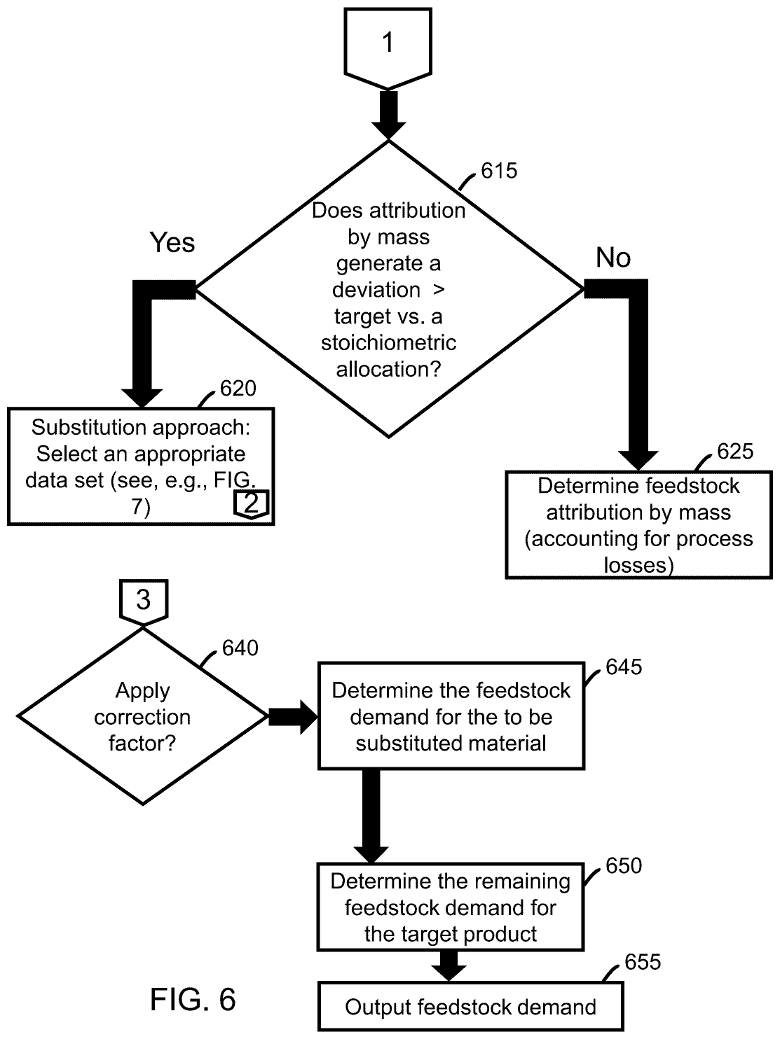

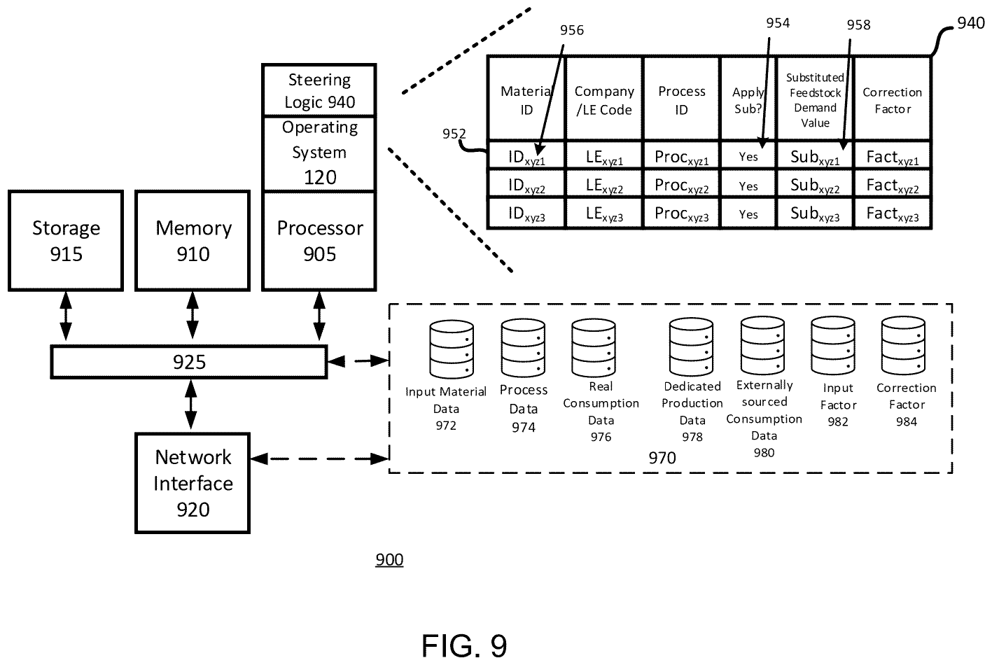

As shown by FIG. 6 at 615, the operating system may then compare the feedstock demand as calculated by mass attribution to the feedstock demand (for the process or process step) as calculated by stoichiometric attribution. Attribution by stoichiometry refers to the method of allocating the amount of feedstocks used in the production process to each co-product based on the stoichiometric ratios of the chemical reaction(s) involved in the process. This method involves calculating the theoretical amounts of each feedstock required to produce a given amount of each co-product based on the balanced chemical equation(s) of the reaction(s) involved in the process. In some embodiments, the operating system references a steering logic (e.g., steering logic 940, shown in FIG. 9) to determine whether the mass attribution calculation deviates from the stoichiometric attribution. The steering logic may include an entry (or flag) indicating whether the mass attribution calculation deviates from the stoichiometric attribution by a target value (e.g., FIG. 9 at 954). The target value may indicate an acceptable range for a deviation between the attribution by mass and the attribution by stoichiometry. The term “deviation value” may refer to the amount by which the mass attribution calculation deviates from the stoichiometric attribution. The target value and the deviation value may be expressed as a percentage (e.g., 5%, 10%, 20%, etc.).

The steering logic may include a collection of data organized in a structured way. For example, the steering logic may be a data structure that organizes data (e.g., into rows and columns).

The steering logic may have a row (or other data structure) corresponding to the co-product (e.g., as shown by 952 in FIG. 9). The row corresponding to the co-product may include a field that stores a value indicating whether, for that co-product, the mass attribution calculation deviates from the stoichiometric attribution by a target value (e.g., as shown by 954 in FIG. 9).

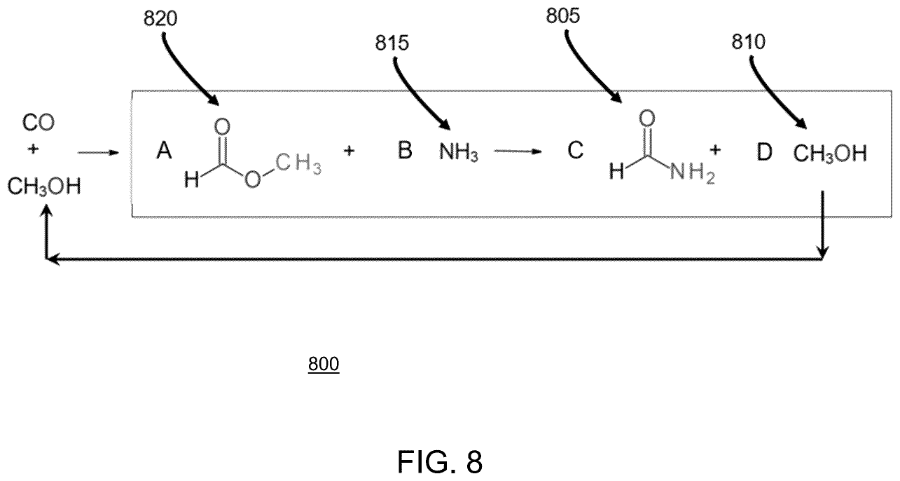

FIG. 8 illustrates an example of a chemical process for which operating system 120 may apply the substitution approach. Chemical process 800 produces two co-products: formamide (FA) and methanol (MeOH) (as shown by 805 and 810, respectively). FA 805 is the intended product and MeOH 810 is the by-product. Chemical process 800 involves reacting ammonia (NH₃) 815 with methyl formate 820. When applying mass attribution, FA 805 and MeOH 810 would get the same feedstock demand (on a per kg basis). But the molecular composition of the two co-products is very different. For example, the nitrogen from ammonia 815 is completely in FA 805. There is no nitrogen in MeOH 810. Therefore, feedstock demand as calculated by stoichiometry would be very different than the feedstock demand as calculated by mass attribution. In such cases, operating system 120 may apply a substitution approach (to calculate the feedstock demand for, as an example, MeOH 810).

If the deviation between the two calculations does not exceed a target value, then the operating system continues with the feedstock demand calculation using attribution by mass (at 625). If, however, the deviation between the two calculations does exceed the threshold value, then the operating system will apply a substitution approach to determine a feedstock demand for at least one of the co-products as shown by 620. In some embodiments the target value is 10% and in other embodiments a different threshold amount may be used.

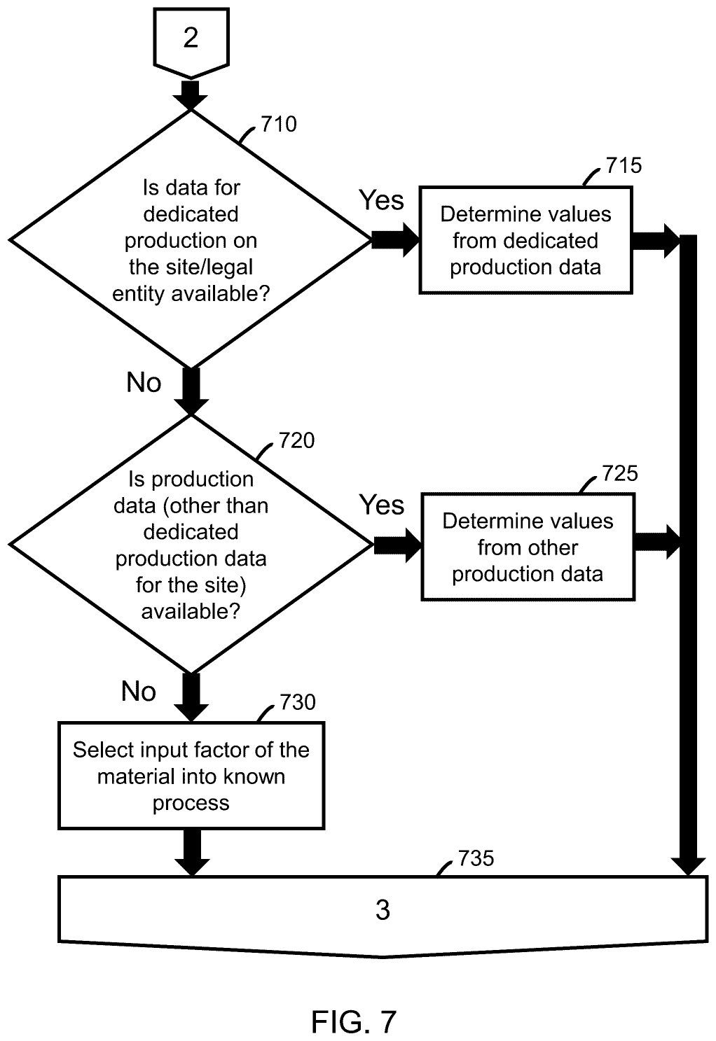

FIG. 7 is a flow diagram illustrating selected aspects of determining the feedstock demand for a co-product using a substitution method, according an embodiment of the disclosure. The operating system may check a number of datasets, in priority order, to determine whether the datasets include a substituted feedstock demand value (or, simply, substituted value) for the co-product. The term “substituted value” refers to a feedstock demand value that the operating system will substitute for the feedstock demand value that was determined by mass attribution for the co-product. Referring to 710, the operating system queries a steering logic (e.g., steering logic 940, shown in FIG. 9) to determine if the steering logic includes a feedstock demand value (for the co-product) that is based on dedicated production data (e.g., for the site or legal entity where the production process occurs). If the steering logic includes a feedstock demand value (for the co-product) that is based on dedicated production data, then the operating system substitutes that value for the value that was determined by mass attribution and returns to 640 in FIG. 6. The term “dedicated production data” may refer to data that is specific to a particular production unit, process line, site, legal entity, and/or country. It may include information about the feedstocks used, the production parameters, the quality of the chemical products and the like.

If the steering logic does not include a feedstock demand value that is based on dedicated production data, then the operating system may query the steering logic to determine if it includes a feedstock demand value (for the co-product) that is based on non-dedicated production data at 720. The term “non-dedicated production” data may refer to data that is not specific to a particular unit (or line, site, legal entity, etc.). Non-dedicated production data may include data from sources external to the chemical production network such as literature values for representative processes. If the steering logic includes a feedstock demand value (for the co-product) that is based on non-dedicated production data, then the operating system substitutes that value for the value that was determined by mass attribution (as shown by 725) and returns to 640 in FIG. 6.

If the steering logic does not include a feedstock demand value that is based on (1) dedicated production data or (2) non-dedicated production data, then the operating system may query the steering logic to select an input factor for the co-product. The term “input factor” refers to data derived from production data for known processes that provides guidance for estimating a feedstock demand. For example, if a co-product is part of a different chemical production process in the chemical production network, the input factor may be an indication of the amount of feedstock consumed to produce the co-product in that chemical production process. The operating system then substitutes that input factor for the value that was determined by mass attribution (as shown by 730) and returns to 640 in FIG. 6.

After selecting a substituted feedstock demand value (or “substituted value), the operating system determines whether to apply a correction factor to the substituted value at 640 (in FIG. 6). The term “correction factor” refers to a factor used to adjust the substituted value if, for example, the concentration of the co-product is less than 100% or if one or more additional process steps are needed to purify or concentrate the co-product. For example, if only 90% of the mass of the co-product is of usable quality, then the correction factor is used to adjust the substituted value to reflect the reduced amount of usable mass of the co-product.

The operating system substitutes the mass attribution feedstock demand value (for the co-product) with the selected substituted value at 645. The operating system then determines the feedstock demand for the second co-product (e.g., the second chemical product) at 650. The calculation of the feedstock demand for the second co-product may be based, at least in part, on the resource balancing between the input materials and the resulting chemical products. For example, the input resources (such as mass and the feedstock demand) are generally balanced with the output resources as shown by equations 1 through 5.

$$\begin{matrix}{M}_{1} + {M}_{2} \to {M}_{3} + {M}_{4} ( where {M}_{i} : Material ) & ( 1 ) \\ {m}_{1} + {m}_{2} \to {m}_{3} + {m}_{4} ( where {m}_{i} : Mass ( kg ) ) & ( 2 ) \\ - ( {m}_{1} {EA}_{1} + {m}_{2} {EA}_{2} ) ∼ ( {m}_{3} {EA}_{3} + {m}_{4} {EA}_{4} ) ( where {EA}_{i} : is , for example , feedstock demand ) & ( 3 ) \\ - INPUT ∼ ( {m}_{3} {EA}_{3} + {m}_{4} {EA}_{4} ) & ( 4 ) \\ {\sum }_{i = 1}^{r} - {m}_{l} {EA}_{i} ≅ {\sum }_{i = x - r + 1}^{x} {m}_{i} {EA}_{l} & ( 5 )\end{matrix}$$

The operating system may access the input material data and the consumption data (from 510 and 520) to determine the value for INPUT (in equation 4). In addition, the selected substituted value may be used for one of the two output terms (e.g., for m₃ EA₃). The remaining unknown value (e.g., m₄ EA₄) may calculated using equation 4.

FIG. 9 is a block diagram illustrating electronic system 900 with operating system 120 that includes steering logic 940, according to the disclosure. Electronic system 900 includes processor 905 which provides processing, operating management, and the execution of the instructions for system 900. Processor 905 may be any type of microprocessor, central processing unit, processing core, field programmable gate array (FPGA), application specific integrated circuit (ASIC), graphical processing unit, programmable controller, and the like.

Processor 905 is communicatively coupled (e.g., via interconnect 925 and network interface 920) to memory 910, storage 915, and network interface 920. Network interface 920 may be coupled with data source(s) 970 through wired and/or wireless network(s) (and/or combinations thereof).

Data source(s) 970 may include one or more locations or systems where data is stored or generated. Data source(s) 970 may include a wide range of systems or devices that collect, store, or process data. Data source(s) 970 may include one or more databases, file servers, applications, storage devices, and/or memory devices. Data source(s) 970 may be (partly or wholly) internal and/or external to a chemical production network. Data source(s) 970 may include structured and/or unstructured sources of data. Structured data sources include may include those that have pre-defined schema such as relational database. Unstructured data sources may include those that do not have a pre-defined schema such as sensor data. Data source(s) 970 may include data sources for: input material data 972, process data 974, real consumption data 976, dedicated production data 978, externally sourced consumption data 980, input factor 982, and/or correction factor 984. Data source(s) 970 may be coupled with operating system 120 through wired and/or wireless network(s) (and/or combinations thereof).

Electronic system 900 includes steering logic 940. Operating system 120 may access steering logic 940 to determine a substitute feedstock demand value for a co-product (e.g., for a first chemical product). For example, operating system 120 may access steering logic 940 to determine if a material identifier associated with the first chemical product is listed in steering logic 940 (as shown by 956). If so, then operating system 120 may determine a substitute feedstock demand value for the first chemical product using a value stored in steering logic 940 (e.g., the substituted value at 958). Operating system 120 may then apply the process described above with reference to FIGS. 5-7 to determine and output a feedstock demand for a chemical process that produces two or more co-products.

The method according to the present disclosure is particularly useful for production plants which execute interconnected process steps. The term “interconnected” in the context of the present invention means that at least one process step uses two intermediates of different other process steps or uses one intermediate of different other process steps each producing this intermediate or yields two intermediates which are used in two different other process steps. Hence, preferably, the production plant executes interconnected process steps. Even more preferably, the production plant is a chemical production plant executing interconnected process steps. Often, the interconnected process steps are executed in different factories, maybe on different sites, potentially operated by different group companies.

The feedstock demand obtained by the method of the present invention can also be used for optimizing the optimizing the feedstock demand of downstream products. The feedstock demand of the chemical products, for example, may be entered into a database together with other information about the product, such as the producer, the specifications, the price, or the availability. In this way, a manufacturer of downstream products may search for products having desirable environmental impacts such that they contribute a desired impact to the environmental attribute(s) of the downstream product and hence optimize the environmental impact of the downstream product.

The present invention further relates to a non-transitory computer readable data medium storing a computer program including instructions for executing steps of the method according to the present invention. Computer readable data medium include hard drives, for example on a serv-er, USB storage device, CD, DVD or Blue-ray discs. The computer program may contain all functionalities and data required for execution of the method according to the present invention or it may provide interfaces to have parts of the method processed on remote systems, for example on a cloud system.

The present invention further relates to a system or apparatus for determining the environmental attribute of a product produced in a production process of a production plant.

Unless explicitly described differently hereafter, the description relating to the method also applies to the system or apparatus. The system or apparatus can be a computing device, for example a computer, tablet, or smartphone, or a distributed computing system or apparatus or apparatus such as a cloud system. Often the computing device has a network connection in order to communicate with other computing devices, such as servers or a cloud network.

FIG. 10 shows a schematic view of a consolidation system for consolidating data in a chemical production network. Production entities C1 and C2 may be different production plants, production sites, legal entities, group companies, and the like. Each production entity provides process data 1001, 1004, consumption data 1002, 1006 and input material data 1003, 1008 through an interface to consolidation system 1010 (and consolidation subsystems 1012-1016).

The consolidation system 1010 gathers and consolidates a wide range of data from chemical production network 1010 to enable operating system 120 to monitor and manage the chemical production network. For example, consolidation subsystem 1012 may consolidate the process data to identify intermediates produced by one production entity and used by a different production entity. Consolidation subsystem 1014 may consolidate the consumption data to provide operating system 120 with consumption data by site, by legal entity, by group company, by country, etc. Consolidation subsystem 1016 may similarly consolidate input material data to provide operating system 120 with input material data by site, by legal entity, by group company, by country, and the like. One or more of consolidation sub systems 1012-1016 may consolidate the environmental attribute of each input material 602, 606 to arrive at one list of input materials with associated environmental attributes.

Electronic system 1000 includes input (or input unit) 1020 which may be configured to receive (i) input material data associated with one or more input materials to a chemical production process, (ii) process data for one or more process steps in the chemical production process that may be required to make chemical products from the one or more input materials, (iii) and consumption data indicating the feedstock demand for chemical products. In the present disclosure, the chemical production process produces two or more co-products (e.g., a first chemical product and a second chemical product). Processor or processing unit 1030 is configured to determine a feedstock demand of one or more of the co-products (e.g., for a first chemical product).

According to the disclosure, processing unit 1030 determines the feedstock demand of a co-product based on steering logic. For example, processing unit 1030 may reference a digital file (such as a lookup table, a database, a memory or storage location, etc.) that contains the feedstock demand of a co-product based on data accessed by the steering logic. Processing unit 1030 may take into account the information obtained from the input unit 1020 and consolidating system 1010 to arrive at the feedstock demand of the co-product. Output or output unit 1040 is configured to output the feedstock demand of the first chemical product.

The present disclosure has been described in conjunction with preferred embodiments and examples as well. However, other variations can be understood and effected by those persons skilled in the art and practicing the claimed invention, from the studies of the drawings, this disclosure and the claims.

Any steps presented herein can be performed in any order. The methods disclosed herein are not limited to a specific order of these steps. It is also not required that the different steps are performed at a certain place or in a certain computing node of a distributed system, i.e. each of the steps may be performed at different computing nodes using different equipment/data processing.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

Any disclosure and embodiments described herein relate to the methods, the systems, devices, the computer program element lined out above and vice versa. Advantageously, the benefits provided by any of the embodiments and examples equally apply to all other embodiments and examples and vice versa.

All terms and definitions used herein are understood broadly and have their general meaning.

Any disclosure and embodiments described herein are mere examples for implementing the method, the system or application device disclosed herein and shall not be considered limiting.

1. A computer-implemented method for determining an input material demand for two or more chemical products produced in a chemical production process of a production plant comprising:
receiving input material data associated with one or more input materials to the chemical production process;
receiving process data for one or more process steps in the chemical production process;
receiving consumption data indicating an amount of feedstock associated with producing two or more chemical products;
identifying based on the process data at least one process step producing from the one or more input materials two or more chemical products, wherein the two or more chemical products includes a first chemical product and a second chemical product;
determining based, at least in part, on a mass allocation calculation a mass fraction feedstock demand for the first chemical product;
determining based, at least in part, on a stoichiometric allocation calculation a stoichiometric-based feedstock demand for the first chemical product;
comparing the mass fraction feedstock demand for the first chemical product with the stoichiometric-based feedstock demand for the first chemical product to determine a deviation value for the first chemical product;
determining if the deviation value for the first chemical product exceeds a target value;
determining based, at least in part, on steering logic a substituted feedstock demand for the first chemical product, if the deviation value for the first chemical product exceeds the target value;
calculating a feedstock demand for the second chemical product based, at least in part, on the substituted feedstock demand for the first chemical product and the consumption data; and
outputting the substituted feedstock demand for the first chemical product and the feedstock demand for the second chemical product.

2. The computer-implemented method of claim 1, wherein determining based, at least in part, on steering logic the substituted feedstock demand for the first chemical product, if the deviation value for the first chemical product exceeds the target value further comprises:
determining if the steering logic includes dedicated production data associated with the first chemical product; and
selecting the substituted feedstock demand for the first chemical product based, at least in part, on the dedicated production data associated with the first chemical product, if the steering logic includes dedicated production data associated with the first chemical product.

3. The computer-implemented method of claim 2, wherein determining based, at least in part, on steering logic the substituted feedstock demand for the first chemical product, if the deviation value for the first chemical product exceeds the target value further comprises:
if the steering logic does not include dedicated production data associated with the first chemical product, determining if the steering logic includes externally sourced production data associated with the first chemical product; and
selecting the substituted feedstock demand for the first chemical product based, at least in part, on the externally sourced production data associated with the first chemical product, if the steering logic includes externally sourced production data associated with the first chemical product.

4. The computer-implemented method of claim 3, wherein determining based, at least in part, on steering logic the substituted feedstock demand for the first chemical product, if the deviation value for the first chemical product exceeds the target value further comprises:
if the steering logic does not include externally sourced production data associated with the first chemical product, determining an input factor associated with the first chemical product; and
selecting the substituted feedstock demand for the first chemical product based, at least in part, on the input factor associated with the first chemical product.

5. The computer-implemented method according to claim 1, wherein determining based, at least in part, on steering logic the substituted feedstock demand for the first chemical product, if the deviation value for the first chemical product exceeds the target value further comprises determining whether to apply a correction factor to the substituted feedstock demand for the first chemical product based, at least in part on the steering logic.

6. The computer-implemented method according to claim 1, wherein selecting the substituted feedstock demand for the first chemical product comprises selecting a substituted sustainable feedstock demand for the first chemical product.

7. The computer-implemented method according to claim 1, wherein calculating the feedstock demand for the second chemical product based, at least in part, on the substituted feedstock demand for the first chemical product comprises selecting a substituted sustainable feedstock demand for the second chemical product based, at least in part, on the substituted feedstock demand for the first chemical product.

8. The computer-implemented method according to claim 1, further comprising:
determining if the first chemical product and/or the second chemical product contain hydrogen with a mass share above a threshold value; and
determining based, at least in part, on an energy content allocation calculation an energy content feedstock demand for the first chemical product, if the first chemical product and/or the second chemical product contain hydrogen with a mass share above the threshold value.

9. A non-transitory computer readable data medium storing a computer program including instructions for executing steps of the method according to claim 1.

10. A system for determining an input material demand for two or more chemical products produced in a chemical production process of a production plant comprising:
an input configured to receive (i) input material data associated with one or more input materials to the chemical production process and (ii) process data for one or more process steps in the chemical production process;
a processor configured to (i) identify based on the process data at least one process step producing from the one or more input materials two or more chemical output products, wherein the two or more chemical products includes a first chemical product and a second chemical product (ii) determine based, at least in part, on a mass allocation calculation a mass fraction feedstock demand for the first chemical product (iii) determine based, at least in part, on a stoichiometric allocation calculation a stoichiometric-based feedstock demand for the first chemical product (iv) compare the mass fraction feedstock demand for the first chemical product with the stoichiometric-based feedstock demand for the first chemical product to determine a deviation value for the first chemical product (v) determine if the deviation value for the first chemical product exceeds a target value (vi) determine based, at least in part, on steering logic a substituted feedstock demand for the first chemical product, if the deviation value for the first chemical product exceeds the target value and (vii) calculate a feedstock demand for the second chemical product based, at least in part, on the substituted feedstock demand for the first chemical product; and
an output configured to output the substituted feedstock demand for the first chemical product and the feedstock demand for the second chemical product.

11. The system according to claim 10, wherein the input comprises an interface to a consolidation system which collects data from different production plant(s), wherein the consolidation system consolidates the process data to identify intermediates produced by different production plants.

12. The system according to claim 10, wherein the output comprises a user interface configured to display the substituted feedstock demand for the first chemical product and the feedstock demand for the second chemical product.

13. The system according to claim 10, wherein the processor configured to determine based, at least in part, on steering logic a substituted feedstock demand for the first chemical product, if the deviation value for the first chemical product exceeds the target value further comprises a processor to:
determine if the steering logic includes dedicated production data associated with the first chemical product; and
select the substituted feedstock demand for the first chemical product based, at least in part, on the dedicated production data associated with the first chemical product, if the steering logic includes dedicated production data associated with the first chemical product.

14. The system according to claim 10, wherein the processor configured to determine based, at least in part, on steering logic a substituted feedstock demand for the first chemical product, if the deviation value for the first chemical product exceeds the target value further comprises a processor to:
if the steering logic does not include dedicated production data associated with the first chemical product, determine if the steering logic includes externally sourced production data associated with the first chemical product; and
select the substituted feedstock demand for the first chemical product based, at least in part, on the externally sourced production data associated with the first chemical product, if the steering logic includes externally sourced production data associated with the first chemical product.

15. The system according to claim 10, wherein the processor configured to determine based, at least in part, on steering logic a substituted feedstock demand for the first chemical product, if the deviation value for the first chemical product exceeds the target value further comprises a processor to:
if the steering logic does not include externally sourced production data associated with the first chemical product, determine an input factor associated with the first chemical product; and
select the substituted feedstock demand for the first chemical product based, at least in part, on the input factor associated with the first chemical product.
